(19) United States
(12) Patent Application Publication
(10) Pub. No.: US 2020/0056338 A1
(43) Pub. Date: Feb. 20, 2020

(54) SIGN POST ANCHORING DEVICE

(71) Applicant: Frank S. COGLITORE, Bangor, ME (US)

(72) Inventor: Frank S. COGLITORE, Bangor, ME (US)

(21) Appl. No.: 16/103,525

(22) Filed: Aug. 14, 2018

(51) Int. Cl. E01F 9/685; E04H 12/22

(52) U.S. Cl. CPC E01F 9/685; G09F 7/18; E04H 12/2269; E04H 12/2215

(57) ABSTRACT

A sign post anchoring device having a receiver to engage with the lower portion of a sign post and an anchor mechanism to engage with the ground, with the anchor mechanism configured to allow for easy installation into the ground by use of a power drill and to enhance stability of the sign post so that it remains in a desired upright orientation.

### BACKGROUND OF THE INVENTION

### 1. Technical Field

The present invention relates generally to tools used in the signage industry. More particularly, the present invention relates to a device used to temporarily anchor a sign post into the ground.

### 2. Description of Prior Art

When a sign post is erected, it may be permanently installed, or it may be temporarily installed. Permanently installed sign posts are often used to signify a business location, or road directions, or general information, and typically are fairly difficult to install and remove, requiring excavation equipment and materials to secure the sign post in place, with the goal of having the sign posts remain securely standing in place for long periods of time. Temporary sign posts are often used to signify short term events, such as political elections, retail promotions, ephemeral information, and real estate offerings. By their nature, temporarily installed sign posts need to be easy to install and easy to remove. However, during the period of time they are erected, they also have the goal of remaining securely standing in place.

The current art for temporarily installed sign posts includes wire frame sign posts (usually seen for political signs), single stake sign posts (having a sharpened lower portion for inserting directly into the ground), and larger sign posts with cross pieces. The latter are typically used to signify real estate transactions, such as “For Sale” signs and “Sale Pending” signs. Such sign posts are typically fairly heavy, though they can be manipulated by a single individual. They need to be securely affixed to the ground and remain standing in an upright position, otherwise potential buyers may be turned off by sloppily tilted signs. The typical real estate sign is too large to have its lower portion configured as a sharpened stake, and therefore is anchored to the ground by use of a separate spiked anchoring device. That is, a metal device having a downward extending, sharpened spike is attached to the lower end of the sign post, and then the spike is driven into the ground by force, usually by use of a sledge hammer striking the top of the sign post. This often results in the sign going into the ground at an angle, or perhaps the anchoring device becomes damaged if the spike strikes an unseen buried rock. Even when the sign is properly installed, it takes considerable effort to wield the sledge hammer. Finally, even a properly installed sign post will tend to tilt over time, because the single spike presents only one point of contact with the ground and the weight of the sign post can easily leverage the spike out of position.

It has thus been demonstrated that there is a need for a device for temporarily anchoring a large sign post securely to the ground which is easy to install and which retains the sign post in the desired upright orientation over time.

It is therefore an object of the present invention to present a sign post anchoring device which is easy to install and remove.

It is a further object of the present invention to present a sign post anchoring device which securely holds a sign post in the desired upright orientation over time.

It is yet a further object of the present invention to present a sign post anchoring device which is less likely to be damaged during installation.

It is yet a further object of the present invention to present a sign post anchoring device that can be adapted to differently configured sign posts.

Other objects of the present invention will be readily apparent from the description that follows.

### SUMMARY OF THE INVENTION

It is to be understood that the foregoing and following description of the invention is intended to be illustrative and exemplary rather than restrictive of the invention as claimed. These and other aspects, advantages, and features of the invention will become apparent to those skilled in the art after review of the entire specification, accompanying figures, and claims incorporated herein.

The sign post anchoring device of the present invention comprises a receiver and an anchor mechanism. The receiver is adapted to engage with differently configured sign posts, securely retaining the device to the lower portion of the sign post, and an anchor mechanism, adapted to engage with the ground. The anchor mechanism is configured to be easily installed into the ground by use of a power drill. It is also configured to provide multiple points of support to the sign post, thereby minimizing the potential for tilting or otherwise moving out of position. The receiver and anchor mechanism are affixed to each other.

In one embodiment, the anchor mechanism of the device of the present invention comprises a pair of anchor prongs which extend downward from the receiver, parallel to each other. A power drill is used to create a pair of holes in the ground, and the anchor prongs are inserted into the holes. Optional stabilizers may be incorporated to provide further lateral support to the sign post. The receiver may be configured to receive the lower portion of the sign post within its hollow interior (a female-to-male connection configuration), or it may be configured to have a hollow lower portion of the sign post placed onto it (a male-to-female connection configuration). Additional optional securing devices such as screws or pins may be used to secure the lower portion of the sign post to the receiver.

### DETAILED DESCRIPTION OF THE DRAWINGS

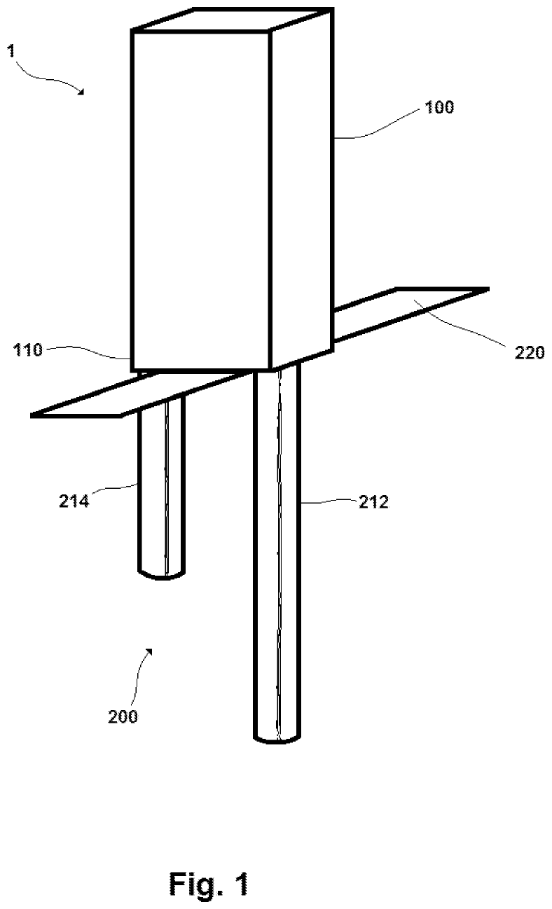

FIG. 1 is a perspective side view of one embodiment of the device of the present invention, depicting a rectangular receiver, an anchor mechanism having a pair of asymmetric anchor prongs, and a rectangular stabilizing member.

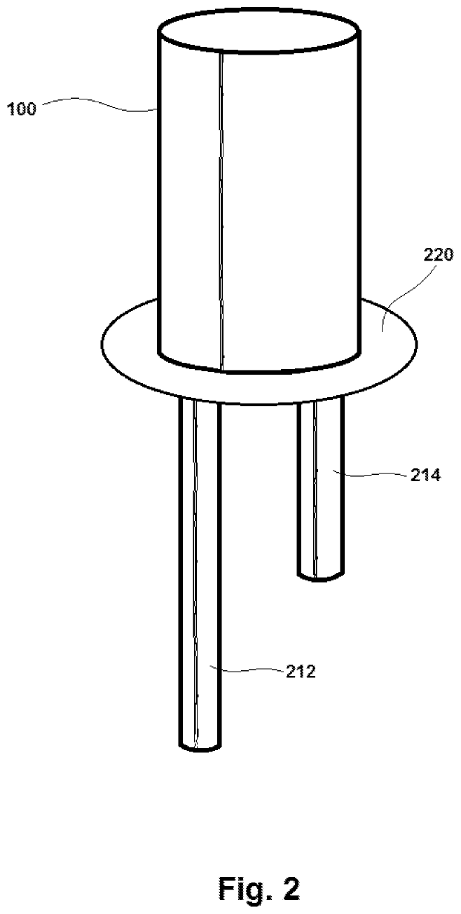

FIG. 2 is a perspective side view of another embodiment of the device of the present invention, depicting a cylindrical receiver, an anchor mechanism having a pair of asymmetric anchor prongs, and a circular stabilizing member.

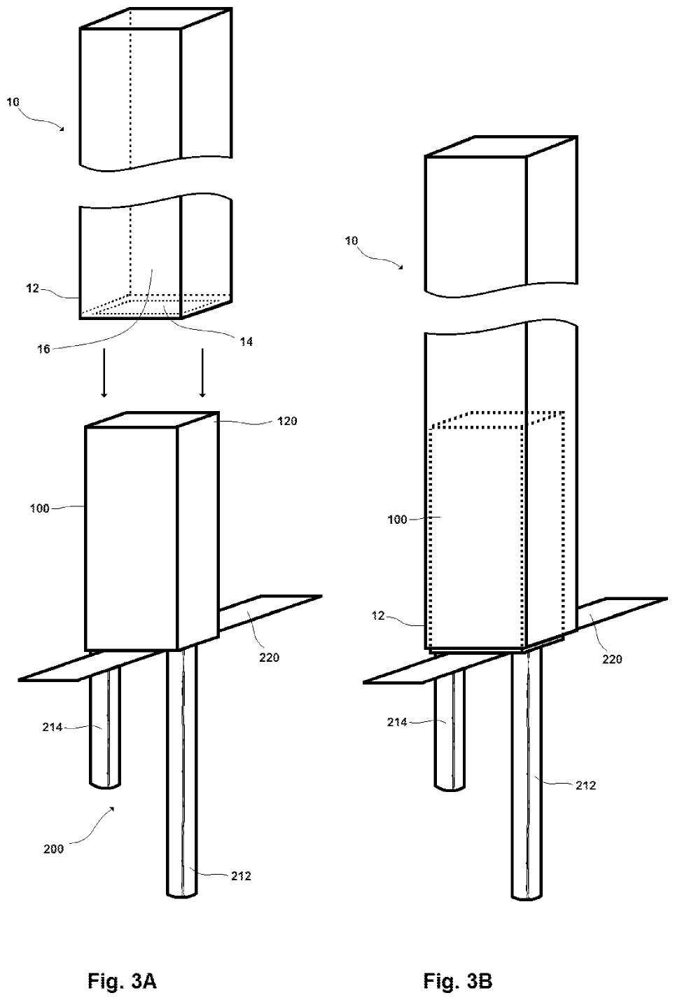

FIG. 3A is a perspective side view of yet another embodiment of the device of the present invention, depicting a rectangular receiver and a partial representation of a signpost (with interior elements of the sign post shown in ghost lines). In this embodiment the lower portion of the sign post fits over and onto the receiver.

FIG. 3B is a perspective side view of the embodiment of the device depicted in FIG. 3A after the lower portion of the sign post has been fitted over and onto the receiver. Portions of the receiver contained within the lower portion of the sign post are shown in ghost lines.

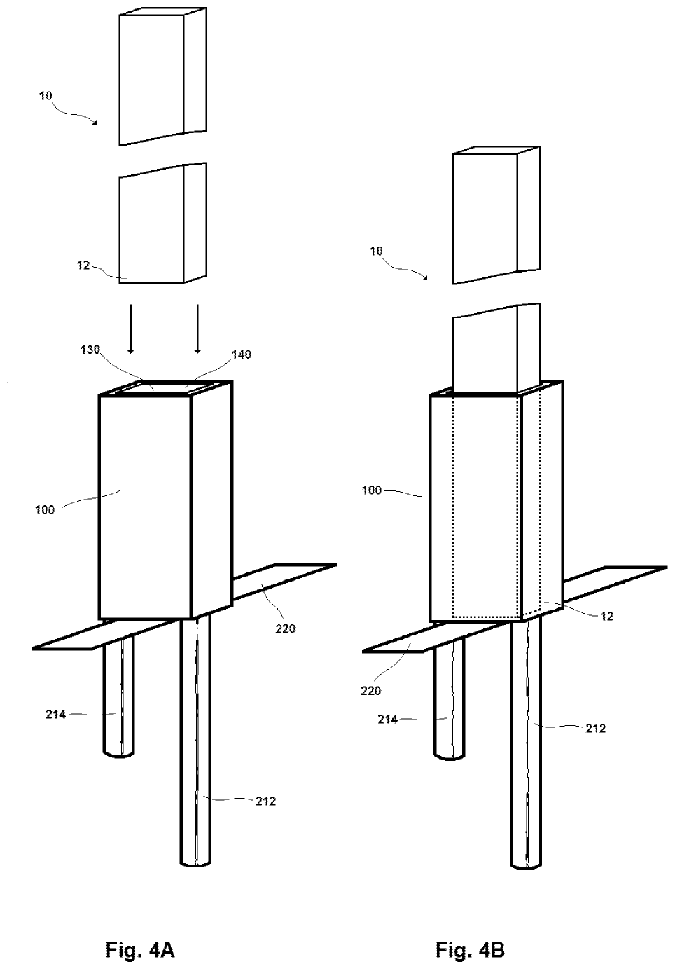

FIG. 4A is a perspective side view of yet another embodiment of the device of the present invention, depicting a rectangular receiver and a partial representation of a signpost. In this embodiment the lower portion of the sign post fits into the receiver.

FIG. 4B is a perspective side view of the embodiment of the device depicted in FIG. 4A after the lower portion of the sign post has been fitted into the receiver. Portions of the lower portion of the sign post contained within the receiver are shown in ghost lines.

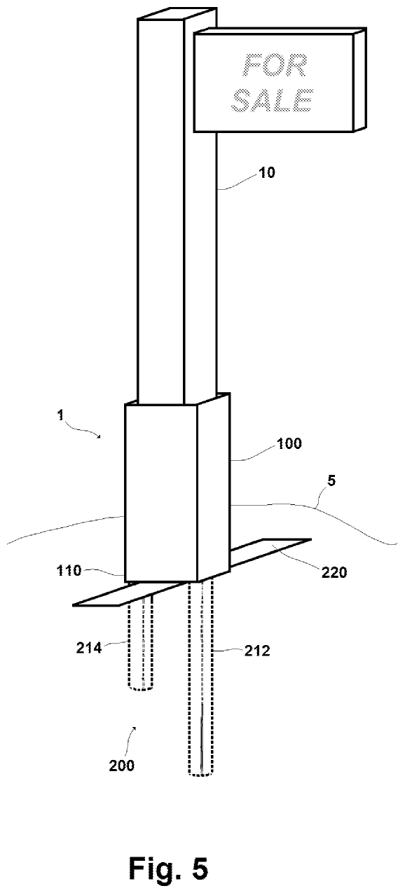

FIG. 5 is a perspective side view of the embodiment of the device depicted in FIG. 4A after the lower portion of the sign post has been fitted into the receiver and the receiver has been anchored to the ground. Portions of the anchor mechanism of the device located below ground are shown in ghost lines.

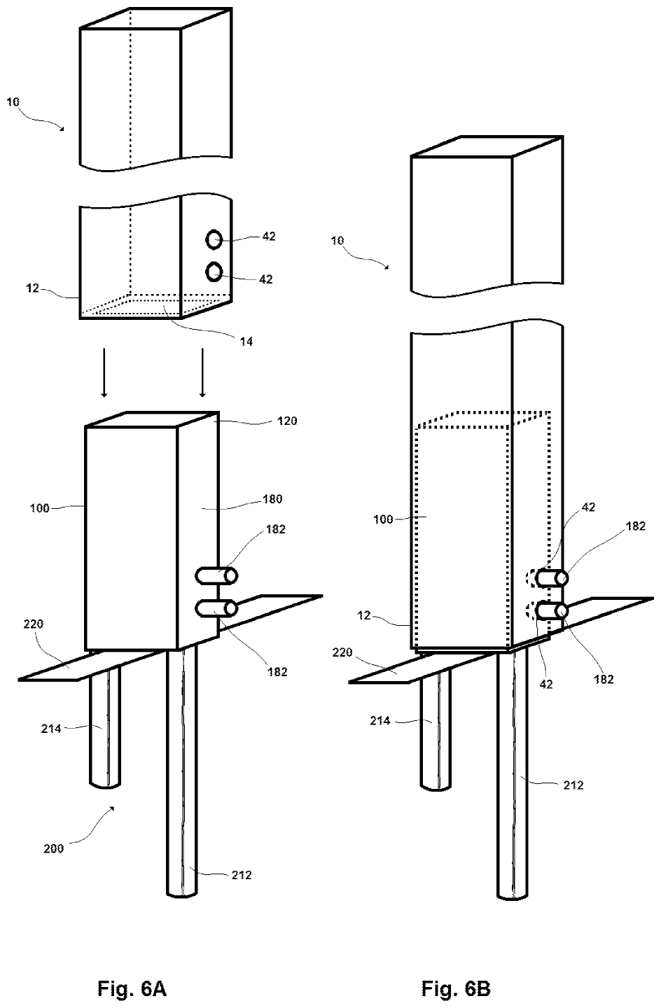

FIG. 6A is a perspective side view of yet another embodiment of the device of the present invention, depicting a rectangular receiver having pins extending therefrom and a partial representation of a signpost having apertures corresponding to the receiver pins (with interior elements of the sign post shown in ghost lines). In this embodiment the lower portion of the sign post fits over and onto the receiver.

FIG. 6B is a perspective side view of the embodiment of the device depicted in FIG. 6A after the lower portion of the sign post has been fitted over and onto the receiver, then slid laterally so that the receiver pins extend through the apertures formed in the side of the lower portion of the sign post. Portions of the receiver contained within the lower portion of the sign post are shown in ghost lines.

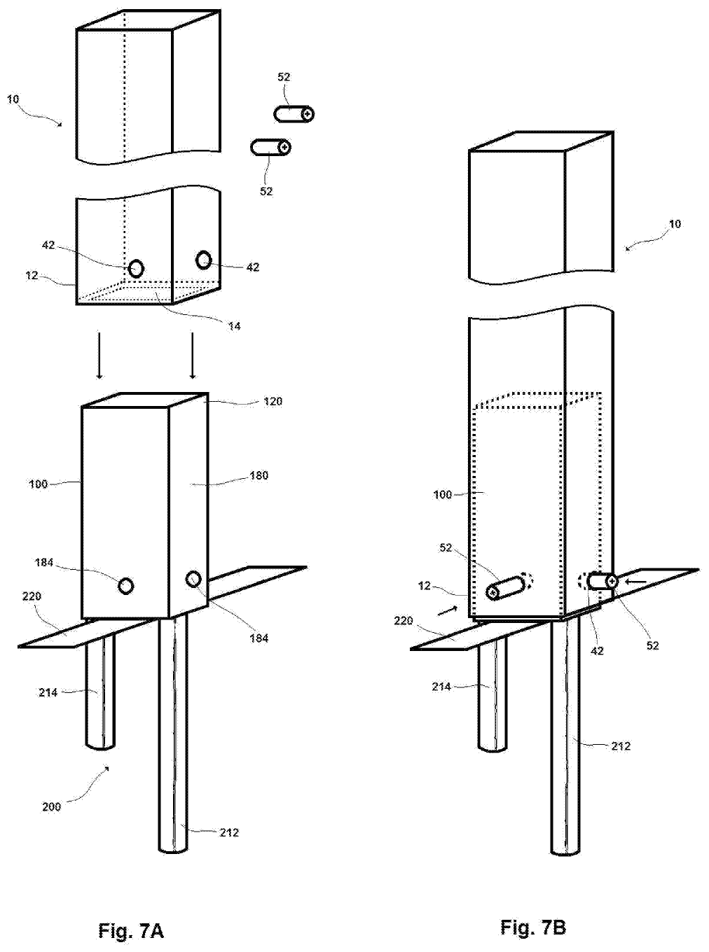

FIG. 7A is a perspective side view of yet another embodiment of the device of the present invention, depicting a rectangular receiver having apertures formed into its sides and a partial representation of a signpost having apertures corresponding to the receiver apertures (with interior elements of the sign post shown in ghost lines). Separate pins are also shown. In this embodiment the lower portion of the sign post fits over and onto the receiver.

FIG. 7B is a perspective side view of the embodiment of the device depicted in FIG. 7A after the lower portion of the sign post has been fitted over and onto the receiver, with the apertures aligned, and then the pins being inserted into and through the corresponding apertures of the sign post and receiver. Portions of the receiver contained within the lower portion of the sign post are shown in ghost lines.

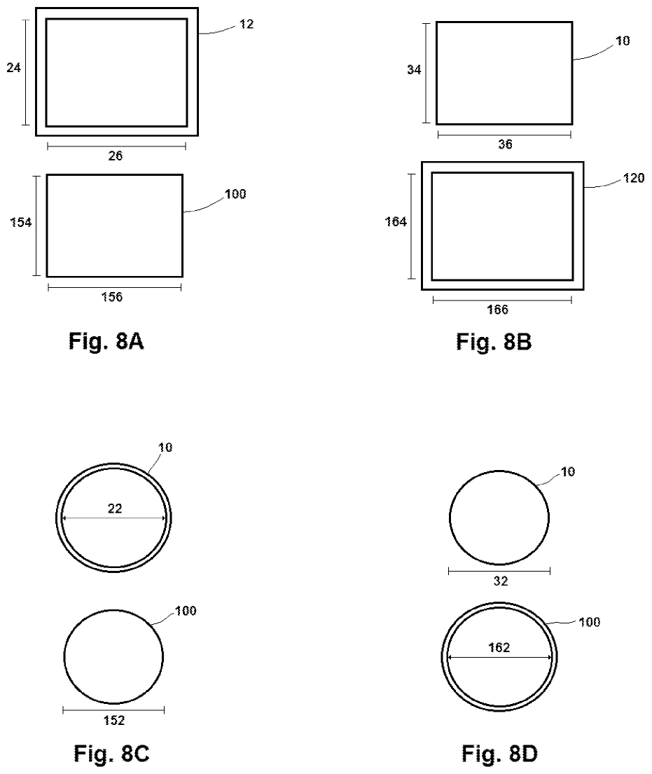

FIG. 8A is a plan bottom view of the lower portion of the sign post (upper image) depicted in FIGS. 3A and 3B and a plan top view of the receiver (lower image) depicted in FIGS. 3A and 3B, in order to show the various inside and outside diameters of the lower portion of the sign post and receiver.

FIG. 8B is a plan bottom view of the lower portion of the sign post (upper image) depicted in FIGS. 4A and 4B and a plan top view of the receiver (lower image) depicted in FIGS. 4A and 4B, in order to show the various inside and outside diameters of the lower portion of the sign post and receiver.

FIG. 8C is a plan bottom view of the lower portion of the sign post (upper image) and a plan top view of the receiver (lower image) whereby the lower portion of the sign post is cylindrical and fits over and onto a cylindrical receiver, in order to show the various inside and outside diameters of the lower portion of the sign post and receiver.

FIG. 8D is a plan bottom view of the lower portion of the sign post (upper image) and a plan top view of the receiver (lower image) whereby the lower portion of the sign post is cylindrical and fits into a cylindrical receiver, in order to show the various inside and outside diameters of the lower portion of the sign post and receiver.

### DETAILED DESCRIPTION OF THE INVENTION

One embodiment of the sign post anchoring device 1 of the present invention comprises a receiver 100 and an anchor mechanism 200. See FIG. 1. The anchor mechanism 200 is affixed to the receiver 100. The receiver 100 is configured to engage with the lower end 12 of a sign post 10, and the anchor mechanism 200 is configured to be inserted into a portion of the ground 5. So configured, when the sign post 10 is in engagement with the receiver 100 of the anchoring device 1, it is held in a substantially vertical orientation relative to the ground 5 when the anchor mechanism 200 is inserted into the ground 5. See FIG. 5.

In the preferred embodiment of the present invention, the anchor mechanism 200 extends downward from the bottom portion 110 of the receiver 100 in a substantially parallel orientation to a longitudinal axis of the receiver 100. In the most preferred embodiment of the present invention, the anchor mechanism 200 is comprised of a first anchor prong 212 and a second anchor prong 214. See FIG. 1. Each anchor prong 212,214 is an elongate, rigid rod, and the two anchor prongs 212,214 are spaced apart from each other and oriented substantially parallel to each other. Each anchor prong 212,214 is configured to be inserted into the ground 5. This configuration minimizes rotation of the device 1 when it is anchored to the ground 5.

The anchor prongs 212,214 may be constructed of any durable material, but in the preferred embodiments they are constructed of iron or steel. Other materials may also be used, such as aluminum, composites, or hard plastics. In the most preferred embodiments the anchor prongs 212,214 are cylindrical and may be grooved or ribbed along their sides (partially or entirely). Their distal ends may be flat or pointed. Each anchor prong 212,214 may be between six and twenty-four inches in length, with preferred embodiments having anchor prongs 212,214 of between twelve and eighteen inches in length. The cylindrical shape of the anchor prongs 212,214 allows for an improved method of installation. Rather than forcing the anchoring mechanism 200 into the ground 5 by pounding on the top of the device 1, such as with a sledge hammer, a power drill may be used to create a pair of holes in the ground to receive the anchor prongs 212,214. Once inserted, the grooves or ribs on the sides of the anchor prongs 212,214 help retain the device in the ground 5. Other configurations of the anchor prongs 212,214 are also contemplated, such as anchor prongs 212,214 having a square cross-section or an oval cross section, or some other shape, and having smooth sides.

In one embodiment where the anchoring mechanism 200 comprises a pair of anchor prongs 212,214, the first anchor prong 212 is longer than the second anchor prong 214. See FIG. 1. In this configuration the shorter anchor prong may be a short as six inches and the longer anchor prong may be as long as twenty-four inches. In a preferred embodiment the shorter anchor prong may be twelve inches long and the longer anchor prong may be eighteen inches long. In yet another embodiment the shorter anchor prong may be eighteen inches long and the longer anchor prong may be twenty-four inches long. Other lengths of the anchor prongs 212,214 are also contemplated. The anchor prongs 212,214 may have any suitable diameter, from as little as ⅜ of an inch to one inch. In a preferred embodiment their diameters are each ½ inch. One example uses #4 rebar for the anchor prongs 212,214. This uneven length configuration of the anchor prongs 212,214 greatly enhances the ease of installation when using a power drill: first, a single hole is drilled into the ground 5, then the longer anchor prong is inserted into the hole. When the shorter anchor prong touches the ground 5, that location is marked, the device 1 is rotated out of the way (with the longer anchor prong still in its hole), and the second hole is drilled into the ground 5 at the location previously marked. Once the second hole is drilled the device is rotated back and the shorter anchor prong fits perfectly into the second hole.

In another embodiment of the present invention the anchoring mechanism 200 of the sign post anchoring device 1 further comprises a stabilizing member 220. See FIG. 1. The stabilizing member 220 is affixed to the bottom 110 of the receiver 100 and is oriented substantially perpendicular to the longitudinal axis of the receiver 100. The stabilization member 220 rests against the ground 5 when the anchor mechanism 200 is inserted into the ground 5. This further enhances the stability of the device 1, minimizing lateral movement of the sign post 10 that is anchored to the ground 5 by the device 1. The stabilizing member 220 may be constructed of any durable material, but in the preferred embodiments it is constructed of iron or steel. Other materials may also be used, such as aluminum, composites, or hard plastics. The stabilizing member 220 can extend from the receiver 100 at any length, but in the preferred embodiments it extends between two and six inches from the receiver 100 in either direction.

In one variant of this embodiment, the stabilizing member 220 is planar and elongate and is located between the first anchor prong 212 and the second anchor prong 214. See FIG. 1. The longitudinal axis of the stabilizing member 220 is oriented perpendicular to the axis between the first anchor prong 212 and the second anchor prong 214. Thus configured, the stabilizing member 220 and the two anchor prongs 212,214 form a cross structure, minimizing lateral movement of the sign post 10 in multiple directions. In another variant of this embodiment, the stabilizing member 220 is planar and substantially circular. See FIG. 2. Other configurations of the stabilizing member 220 are also contemplated.

The receiver 100 of the device 1 of the present invention may be configured multiple ways. For example, it can be substantially cylindrical with a circular cross-section, or rectangular or square in cross-section, or it can be configured as a male-to-female connection with a sign post 10, or as a female-to-male connection with a sign post 10, and with or without additional securing devices. In each of these configurations, though, the receiver 100 must be elongate and rigid. Each of these variants allows the receiver 100 to be configured for a specific configuration of sign post 10. The receiver 100 may be constructed of any durable material, but in the preferred embodiments it is constructed of iron or steel. Other materials may also be used, such as aluminum, composites, or hard plastics. The receiver 100 may have any suitable height. In the preferred embodiments, the receiver 100 will have a height of between six and twenty-four inches. In the most preferred embodiments, the receiver 100 will have a height of between nine and fifteen inches. In one most preferred embodiment, the receiver 100 will have a height of twelve inches.

In the basic male-to-female connection configuration, the receiver 100 is a post and the sign post 10 has a lower portion 12 having a hollow interior 16. Formed into the bottom of the sign post 10 is a bottom aperture 14, with the bottom aperture 14 providing access into the hollow interior 16 of the lower portion 12 of the sign post 10. The lower portion 12 of the sign post 10 is fitted over and onto the receiver 100 such that an upper portion 120 of the receiver 100 is placed through the bottom aperture 14 of the lower portion 12 of the sign post 10 and into the hollow interior 16 of the lower portion 12 of the sign post 10. See FIGS. 3A and 3B.

In one variant of the male-to-female connection configuration, the receiver 100 is a cylindrical post having a circular cross-section. Likewise, the lower portion 12 of the sign post 10 has a hollow interior 16 having a circular cross-section. The bottom aperture 14 of the lower portion 12 of the sign post 10 has an inside diameter 22 just slightly larger than the outside diameter 152 of the receiver 100. This allows the sign post 10 to fit over and onto the receiver 100. See FIG. 8C.

In another variant of the male-to-female connection configuration, the receiver 100 is a post having a rectangular cross-section. The first outside diameter 154 of the receiver 100 is the straight line distance between a pair of opposite sides of the receiver 100, and the second outside diameter 156 is the straight line distance between the other pair of opposite sides of the receiver 100. The first outside diameter 154 of the receiver 100 is oriented perpendicular to the second outside diameter 156 of the receiver 100. The lower portion 12 of the sign post 10 also has a rectangular cross-section. The first inside diameter 24 of the bottom aperture 14 of the lower portion 12 of the sign post 10 is the straight line distance between a pair of opposite sides of the bottom aperture 14, and the second inside diameter 26 of the bottom aperture 14 of the lower portion 12 of the sign post 10 is the straight line distance between the other pair of opposite sides of the bottom aperture 14. The first inside diameter 24 of the bottom aperture 14 of the lower portion 12 of the sign post 10 is oriented perpendicular to the second inside diameter 26 of the bottom aperture 14 of the lower portion 12 of the sign post 10. The first outside diameter 154 of the receiver 100 is slightly smaller than the first inside diameter 24 of the bottom aperture 14 of the lower portion 12 of the sign post 10, and the second outside diameter 156 of the receiver 100 being slightly smaller than the second inside diameter 24 of the bottom aperture 14 of the lower portion 12 of the sign post 10. This allows the sign post 10 to fit over and onto the receiver 100. See FIG. 8A. This configuration is an improvement over the cylindrical receiver 100, described above, as rotation of the sign post 10 is minimized. A square variant of this configuration is also contemplated, with the first outside diameter 154 of the receiver 100 being equal to the second outside diameter 156 of the receiver 100, and the first inside diameter 24 of the bottom aperture 14 of the lower portion 12 of the sign post 10 being equal to the second inside diameter 26 of the bottom aperture 14 of the lower portion 12 of the sign post 10.

In the basic female-to-male connection configuration, the receiver 10 has a hollow interior 130. Formed into the top of the receiver 100 is a top aperture 140, with the top aperture 140 providing access into the hollow interior 130 of the receiver 100. The lower portion 12 of the sign post 10 is fitted into the receiver 100 such that the lower portion 12 of the sign post 10 is placed through the top aperture 140 of the receiver 100 and into the hollow interior 130 of the receiver 100. See FIGS. 4A and 4B.

In one variant of the female-to-male connection configuration, the top aperture 140 of the receiver 100 has a circular cross-section. Likewise, the lower portion 12 of the sign post 10 has a circular cross-section. The top aperture 140 of the receiver 100 has an inside diameter 162 just slightly larger than the outside diameter 32 of the lower portion 12 of the sign post 10. This allows the sign post 10 to fit into the receiver 100. See FIG. 8D.

In another variant of the female-to-male connection configuration, the top aperture 140 of the receiver 100 has a rectangular cross-section. The first inside diameter 164 of the top aperture 140 of the receiver 100 is the straight line distance between a pair of opposite sides of the top aperture 140 of the receiver 100, and the second inside diameter 166 of the top aperture 104 of the receiver 100 is the straight line distance between the other pair of opposite sides of the top aperture 104 of the receiver 100. The first inside diameter 164 of the top aperture 140 of the receiver 100 is oriented perpendicular to the second inside diameter 166 of the top aperture 140 of the receiver 100. The lower portion 12 of the sign post 10 also has a rectangular cross-section. The first outside diameter 34 of the lower portion 12 of the sign post 10 is the straight line distance between a pair of opposite sides of the lower portion 12 of the sign post 10, and the second outside diameter 36 of the lower portion 12 of the sign post 10 is the straight line distance between the other pair of opposite sides of the lower portion 12 of the sign post 10. The first outside diameter 34 of the lower portion 12 of the sign post 10 is oriented perpendicular to the second outside diameter 36 of the lower portion 12 of the sign post 10. The first outside diameter 34 of the lower portion 12 of the sign post 10 is slightly smaller than the first inside diameter 164 of the top aperture 140 of the receiver 100, and the second outside diameter 36 of the lower portion 12 of the sign post 10 is slightly smaller than the second inside diameter 166 of the top aperture 140 of the receiver 100. This allows the sign post 10 to fit into the receiver 100. See FIG. 8B. A square variant of this configuration is also contemplated, with the first inside diameter 164 of the receiver 100 is equal to the second inside diameter 166 of the receiver 100, and the first outside diameter 34 of the lower portion 12 of the sign post 10 is equal to the second outside diameter 36 of the lower portion 12 of the sign post 10.

In another embodiment of the present invention the sign post anchoring device 1 uses a securing mechanism to better retain the device 1 to the sign post 10. In the male-to-female connection configuration described above, the receiver 100 may comprise one or more pins 182, with each pin 182 being attached to one side 180 of the receiver 100 and extending outward from the receiver 100 in an orientation perpendicular to the longitudinal axis of the receiver 100. These pins 182 are matched by a corresponding number of side apertures 42 located in the side of the lower portion 12 of the sign post 10. See FIG. 6A. The pins 182 and side apertures 42 align with each other when the lower portion 12 of the sign post 10 is placed over and onto the receiver 100. In this configuration, the inside diameter of the lower portion 12 of the sign post corresponding to the side of the sign post 10 having the side apertures 42 formed therein is larger than the corresponding outside diameter of the receiver 100 by at least the length of the pins 182. Once the lower portion 12 of the sign post 10 is placed completely over and onto the receiver 100, the sign post 10 is moved laterally so that the receiver pins 182 extend through the side apertures 42. See FIG. 7B. If desired, a shim may be placed into the hollow interior 16 of the lower portion 12 of the sign post 10 to prevent the sign post 10 from moving laterally.

In another embodiment of the present invention the sign post anchoring device 1 using a securing mechanism, the receiver 100 comprises one or more side apertures 184, with each said side aperture 184 being formed into a side 180 of the receiver 100 and extending inward into the receiver 100, the lower portion 12 of the sign post 10 has one or more side apertures 42 corresponding to the number of side apertures 184 of the receiver 100. See FIG. 7A. Each said side aperture 42 of the lower portion 12 of the sign post 10 aligns with a side aperture 184 of the receiver 100 so that a securing device 52 may be extended through each side aperture 42 of the lower portion 12 of the sign post 10 and a corresponding side aperture 184 of the receiver 100. This variant is applicable to both the male-to-female connection configuration and the female-to-male connection configuration. That is, the apertures 42,184 are aligned when the lower portion 12 of the sign post 10 is fitted over and onto the receiver 100 in the male-to-female connection configuration, and the apertures 42,184 are aligned when the lower portion 12 of the sign post 10 is fitted into the receiver 100 in the female-to-male connection configuration. See FIG. 7B. The securing device 52 used in this variant may be any suitable device, such as a smooth pin, a threaded bolt, a screw, or a dowel. Other configurations of the securing device 52 are also contemplated. This variant can be used where only the receiver 100 initially has the side apertures 184. A sign post 10 lacking side apertures 42 could be inserted into the receiver 100 (in the male-to-female connection configuration) and then a drill could be used to form the apertures 42 into the lower portion 12 of the sign post 10.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching without departing from the subject or spirit of the invention as defined in the following claims. The exemplary embodiments, along with some variations, were chosen and described in order to best explain the principles of the present invention and its practical application. Those skilled in the art will recognize that many variations are possible within the spirit and scope of the invention in which all terms are meant in their broadest, reasonable sense unless otherwise indicated. Other embodiments not specifically set forth herein are therefore also within the scope of the following claims.

1. A sign post anchoring device comprising
a receiver and an anchor mechanism, with the anchor mechanism being directly affixed to a bottom of the receiver thereby forming a unitary structure;
wherein the receiver is configured to engage with a lower end of a sign post,
the anchor mechanism is configured to be inserted into a portion of ground,
the anchor mechanism extends downward from the bottom of the receiver in a substantially parallel orientation to a longitudinal axis of the receiver, and
the anchor mechanism is comprised of a first anchor prong and a second anchor prong, with the first anchor prong being an elongate, rigid rod, and the second anchor prong being an elongate, rigid rod oriented substantially parallel to the first anchor prong;
whereby the sign post in engagement with the receiver of the sign post anchoring device is held in a substantially vertical orientation relative to the ground when the anchor mechanism is inserted into the ground, and
the first anchor prong is configured to be inserted into the ground and the second anchor prong is configured to be inserted into the ground.

2. (canceled)

3. (canceled)

4. The sign post anchoring device of claim 1 wherein
the first anchor prong has a length and the second anchor prong has a length, with the length of the first anchor prong being greater than the length of the second anchor prong.

5. The sign post anchoring device of claim 1 wherein the anchor mechanism further comprises a stabilizing member, said stabilizing member oriented substantially perpendicular to the longitudinal axis of the receiver;
whereby said stabilization member rests against the ground when the first and second anchor prongs are inserted into the ground.

6. The sign post anchoring device of claim 5 wherein
the stabilizing member is planar and elongate and is located between the first anchor prong and the second anchor prong, with the longitudinal axis of the stabilizing member being oriented perpendicular to an axis between the first anchor prong and the second anchor prong.

7. The sign post anchoring device of claim 1 further comprising a stabilizing member,
said stabilizing member being planar and substantially circular and located at a bottom portion of the receiver and oriented substantially perpendicular to a longitudinal axis of the receiver;
whereby said stabilization member rests against the ground when the anchor mechanism is inserted into the ground.

8. The sign post anchoring device of claim 1 wherein
the receiver is elongate and rigid; and
the sign post has a lower portion having a hollow interior and a bottom aperture, with the bottom aperture providing access into the hollow interior of the lower portion of the sign post;
whereby the lower portion of the sign post is fitted over and onto the receiver such that an upper portion of the receiver is placed through the bottom aperture of the lower portion of the sign post and into the hollow interior of the lower portion of the sign post.

9. The sign post anchoring device of claim 8 wherein
the lower portion of the sign post has a circular cross-section and a bottom aperture, with the bottom aperture having an inside diameter and providing access into the hollow interior of the lower portion of the sign post; and
the receiver is a post having a circular cross-section and an outside diameter, with the outside diameter of the receiver being slightly smaller than the inside diameter of the bottom aperture of the lower portion of the sign post.

10. The sign post anchoring device of claim 8 wherein
the lower portion of the sign post has a rectangular cross-section and a bottom aperture, with the bottom aperture providing access into the hollow interior of the lower portion of the sign post and having a first inside diameter and a second inside diameter, with the first inside diameter of the bottom aperture of the lower portion of the sign post oriented perpendicular to the second inside diameter of the bottom aperture of the lower portion of the sign post; and
the receiver is a post having a rectangular cross-section, a first outside diameter, and a second outside diameter, with the first outside diameter of the receiver being oriented perpendicular to the second outside diameter of the receiver, with the first outside diameter of the receiver being slightly smaller than the first inside diameter of the bottom aperture of the lower portion of the sign post and the second outside diameter of the receiver being slightly smaller than the second inside diameter of the bottom aperture of the lower portion of the sign post.

11. The sign post anchoring device of claim 10 wherein
the sign post has a square cross-section and the first inside diameter of the bottom aperture of the lower portion of the sign post is equal to the second inside diameter of the bottom aperture of the lower portion of the sign post; and
the receiver has a square cross-section and the first outside diameter of the receiver is equal to the second outside diameter of the receiver.

12. The sign post anchoring device of claim 8 wherein
the receiver comprises one or more pins, with each said pin being attached to one side of the receiver and extending outward from the receiver in an orientation perpendicular to a longitudinal axis of the receiver; and
the lower portion of the sign post has one or more side apertures corresponding to the number of receiver pins;
whereby each said side aperture of the lower portion of the sign post aligns with a receiver pin so that each said receiver pin extends through a corresponding side aperture of the lower portion of the sign post when the lower portion of the sign post is fitted over and onto the receiver.

13. The sign post anchoring device of claim 8 wherein
the receiver comprises one or more side apertures, with each said side aperture being formed into a side of the receiver and extending inward into the receiver; and
the lower portion of the sign post has one or more side apertures corresponding to the number of side apertures of the receiver;
whereby each said side aperture of the lower portion of the sign post aligns with a side aperture of the receiver so that a securing device may be extended through each side aperture of the lower portion of the sign post and a corresponding side aperture of the receiver when the lower portion of the sign post is fitted over and onto the receiver.

14. The sign post anchoring device of claim 13 wherein each securing device is one of the group of a pin, a bolt, a screw, and a dowel.

15. The sign post anchoring device of claim 1 wherein
the sign post has a lower portion; and
the receiver is elongate and rigid and has a hollow interior and a top aperture, with the top aperture providing access into the hollow interior of the receiver;
whereby the lower portion of the sign post is fitted into the receiver such that the lower portion of the sign post is placed through the top aperture of the receiver and into the hollow interior of the receiver.

16. The sign post anchoring device of claim 15 wherein
the lower portion of the sign post has a circular cross-section and an outside diameter; and
the receiver is a post having a circular cross-section, with the top aperture of the receiver having an inside diameter and providing access into the hollow interior of the receiver;
whereby the outside diameter of the lower portion of the sign post is slightly smaller than the inside diameter of the top aperture of the receiver.

17. The sign post anchoring device of claim 15 wherein
the lower portion of the sign post has a rectangular cross-section, a first outside diameter, and a second outside diameter, with the first inside diameter of the lower portion of the sign post oriented perpendicular to the second inside diameter of the lower portion of the sign post; and
the receiver is a post having a rectangular cross-section, with the top aperture of the receiver providing access into the hollow interior of the receiver and having a first inside diameter and a second inside diameter, with the first inside diameter of the top aperture of the receiver being oriented perpendicular to the second inside diameter of the top aperture of the receiver,
with the first outside diameter of the lower portion of the sign post being slightly smaller than the first inside diameter of the top aperture of the receiver, and the second outside diameter of the lower portion of the sign post being slightly smaller than the second inside diameter of the top aperture of the receiver.

18. The sign post anchoring device of claim 17 wherein
the sign post has a square cross-section and the first outside diameter of the lower portion of the sign post is equal to the second outside diameter of the lower portion of the sign post; and
the receiver has a square cross-section and the first inside diameter of the top aperture of the receiver is equal to the second inside diameter of the top aperture of the receiver.

19. The sign post anchoring device of claim 15 wherein
the lower portion of the sign post comprises one or more side apertures, with each said side aperture being formed into a side of the lower portion of the sign post and extending inward into the lower portion of the sign post; and
the receiver has one or more side apertures corresponding to the number of side apertures of the lower portion of the sign post;
whereby each said side aperture of the lower portion of the sign post aligns with a side aperture of the receiver so that a securing device may be extended through each side aperture of the lower portion of the sign post and a corresponding side aperture of the receiver when the lower portion of the sign post is fitted over and onto the receiver.

20. The sign post anchoring device of claim 19 wherein each securing device is one of the group of a pin, a bolt, a screw, and a dowel.
